(19) United States
(12) Patent Application Publication
(10) Pub. No.: US 2012/0222674 A1
(43) Pub. Date: Sep. 6, 2012

(54) Breathing Apparatus

(75) Inventors: Kenichi Ono, Tokyo (JP); Genta Santou, Tokyo (JP); Hiroyuki Ide, Tokyo (JP); Osamu Zaitsu, Tokyo (JP)

(73) Assignee: SHIGEMATSU WORKS CO., LTD., Tokyo (JP)

(21) Appl. No.: 13/497,308

(22) PCT Filed: Oct. 1, 2010
(86) PCT No.: PCT/JP10/67245

§ 371 Date: Mar. 21, 2012

(30) Foreign Application Priority Data
Oct. 7, 2009 (JP) 2009-233930
Oct. 7, 2009 (JP) 2009-233931
Oct. 7, 2009 (JP) 2009-233932

(51) Int. Cl. A62B 7/10; A62B 18/10; A62B 18/08; A62B 27/00; A62B 9/04; A62B 18/02

(52) U.S. Cl. 128/202.22; 128/202.27

(57) ABSTRACT

[Object of the Invention] An object of the present invention is to provide a breathing apparatus comprising a face piece for covering the whole face of a user, and a fan unit for operating synchronously with the breath timing of the user, wherein the breathing apparatus comprises a breath monitoring apparatus provided with a diaphragm and a sensor for detecting movement of the diaphragm, and wherein the location of the diaphragm and the sensor is optimized and a transmission path of inhale pressure and exhale pressure to the diaphragm is optimized.

[Disclosure of the Invention] A breath monitoring apparatus comprising a diaphragm and a sensor for detecting movement of the diaphragm is disposed in a fan unit, a space for accommodating the diaphragm and the sensor is disposed independently of an air passage in the fan unit, and the internal space of a nose cup is communicated with the space in the fan unit through a hole formed in the nose cup and a hole formed in the face piece when the fan unit and the nose cup are connected to the face piece.

### TECHNICAL FIELD

The present invention relates to a breathing apparatus comprising a filter, a fan unit, a face piece for covering the whole face of a user, a nose cup for covering the mouth and the nose of the user, and a breath monitoring apparatus, wherein the filter is detachably connected to the fan unit, the fan unit is detachably connected to the face piece from the outside of the face piece, the nose cup is detachably connected to the face piece from the inside of the face piece, and the fan unit operates synchronously with the breath timing of the user detected by the breath monitoring apparatus.

### BACKGROUND ART

Patent Document No. 1 teaches a breathing apparatus comprising a filter, a fan unit, a face piece for covering the whole face of a user, a nose cup for covering the mouth and the nose of the user, and a breath monitoring apparatus, wherein the filter is detachably connected to the fan unit, the fan unit is detachably connected to the face piece from the outside of the face piece, the nose cup is detachably connected to the face piece from the inside of the face piece, and the fan unit operates synchronously with the breath timing of the user detected by the breath monitoring apparatus.

### PRIOR ART DOCUMENT

### Patent Document

Patent Document No. 1: Japanese Patent Laid-Open Publication No. 2009-089794

### DISCLOSURE OF INVENTION

### Problem to be Solved

In the breathing apparatus of Patent Document No. 1, breath timing is detected by a breath monitoring apparatus comprising an exhale valve and a sensor for detecting movement of the exhale valve.

The breath monitoring apparatus comprising an exhale valve and a sensor for detecting movement of the exhale valve has a problem in that micro particulates of dust, water, etc. contaminating the exhaled air are liable to adhere to the sensor to foul it, thereby causing deterioration with age of the sensor because the sensor must be disposed in an exhale passage.

A breath monitoring apparatus comprising a diaphragm and a sensor for detecting movement of the diaphragm also has been used in breathing apparatuses. The breath monitoring apparatus comprising a diaphragm and a sensor for detecting movement of the diaphragm has an advantage in that it need not be disposed in an exhale passage.

Therefore, an object of the present invention is to provide a breathing apparatus comprising a filter, a fan unit, a face piece for covering the whole face of a user, a nose cup for covering the mouth and the nose of the user, and a breath monitoring apparatus, wherein the filter is detachably connected to the fan unit, the fan unit is detachably connected to the face piece from the outside of the face piece, the nose cup is detachably connected to the face piece from the inside of the face piece, and the fan unit operates synchronously with the breath timing of the user detected by the breath monitoring apparatus, and wherein the breath monitoring apparatus comprises a diaphragm and a sensor for detecting movement of the diaphragm, location of the diaphragm and the sensor is optimized, and a transmission path of inhalation/exhalation-induced air pressure fluctuation to the diaphragm is optimized.

The internal pressure of the face piece is desirably kept positive so as to prevent invasion of ambient contaminated air into the face piece. However, the internal pressure of the face piece can become negative when the airflow rate of the fan unit decreases due to clogging of the filter, low power supply battery voltage, or other such cause. In commercial products that are implementations of the breathing apparatus of Patent Document No. 1, an electric power supply cord for connecting the fan unit with a power supply battery independent of the fan unit is provided with a light source activated when the internal pressure of the face piece becomes negative so as to notify the user that it is time to replace the filter, charge the battery, etc.

The light source provided on the electric power supply cord for connecting the fan unit with the power supply battery is hard for the user to notice without taking it in hand and examining it closely. This results in a possibility that the user may fail to notice that the time has come to replace the filter, charge the battery, etc.

Therefore, another object of the present invention is to provide a breathing apparatus comprising a filter, a fan unit, a face piece for covering the whole face of a user, a nose cup for covering the mouth and the nose of the user, and a breath monitoring apparatus, wherein the filter is detachably connected to the fan unit, the fan unit is detachably connected to the face piece from the outside of the face piece, the nose cup is detachably connected to the face piece from the inside of the face piece, and the fan unit operates synchronously with the breath timing of the user detected by the breath monitoring apparatus, and wherein the breathing apparatus further comprises a light source which is activated when the internal pressure of the face piece becomes negative, and the light source is readily noticed by the user when activated.

In the breathing apparatus of Patent Document No. 1, the power supply battery of the fan unit is independent of the fan unit.

In the breathing apparatus of Patent Document No. 1, the fan unit is detachably connected to the front of the face piece and the exhale valve is disposed on the portion of the face piece to which the fan unit is connected.

The power supply battery of the fan unit is desirably accommodated in the fan unit from the viewpoint of the convenience of the breathing apparatus. On the other hand, accommodation of the power supply battery in the fan unit results in increase of the thickness of the fan unit. Therefore, if the exhale valve is disposed on the portion of the front of the face piece to which the fan unit is connected, the fan unit excessively projects from the front of the face peace due to the increase of the thickness thereof caused by the accommodation of the power supply battery and the fact in that a space must be provided between the exhale valve and the fan unit so as to discharge the exhale air in the face piece to the environment. The excessive projection of the fan unit from the front of the face piece causes inconveniency of the breathing apparatus.

Therefore, another object of the present invention is to provide a breathing apparatus comprising a filter, a fan unit, a face piece for covering the whole face of a user, a nose cup for covering the mouth and the nose of the user, and a breath monitoring apparatus, wherein the filter is detachably connected to the fan unit, the fan unit is detachably connected to the face piece from the outside of the face piece, the nose cup is detachably connected to the face piece from the inside of the face piece, and the fan unit operates synchronously with the breath timing of the user detected by the breath monitoring apparatus, and wherein the fan unit is detachably connected to the front of the face piece, the fan unit accommodates the power supply battery, and excessive projection of the fan unit connected to the face piece from the front of the face piece is prevented.

### Means for Achieving the Object

In accordance with the present invention, there is provided a breathing apparatus comprising a filter, a fan unit, a face piece for covering the whole face of a user, a nose cup for covering the mouth and the nose of the user, and a breath monitoring apparatus, wherein the filter is detachably connected to the fan unit, the fan unit is detachably connected to the face piece from the outside of the face piece, the nose cup is detachably connected to the face piece from the inside of the face piece, and the fan unit operates synchronously with the breath timing of the user detected by the breath monitoring apparatus, and wherein the breath monitoring apparatus comprises a diaphragm and a sensor for detecting movement of the diaphragm, the breath monitoring apparatus is disposed in the fan unit, an air passage and a space independent of the air passage for accommodating the diaphragm and the sensor are formed in the fan unit, a hole is formed in the face piece to communicate with the space in the fan unit when the fan unit is connected to the face piece, a hole is formed in the nose cup to communicate with the hole in the face piece when the nose cup is connected to the face piece, and the internal space of the nose cup communicates with the space in the fan unit through the hole in the nose cup and the hole in the face piece when the fan unit and the nose cup are connected to the face piece.

The breath monitoring apparatus is desirably disposed in the fan unit rather than the face piece because the face piece is detached from the fan unit and washed in water. Inhalation/exhalation-induced air pressure fluctuation appears most clearly in the internal space of the nose cup. Therefore, the diaphragm of the breath monitoring apparatus desirably receives air pressure in the internal space of the nose cup.

Location of the diaphragm and the sensor is optimized and a transmission path of inhalation/exhalation-induced air pressure fluctuation to the diaphragm is optimized by disposing the breath monitoring apparatus in the fan unit, forming the space for accommodating the diaphragm and the sensor independent of the air passage in the fan unit, forming a hole in the face piece to communicate with the space for accommodating the diaphragm and the sensor when the fan unit is connected to the face piece, forming a hole in the nose cup to communicate with the hole in the face piece when the nose cup is connected to the face piece, and communicating the internal space of the nose cup with the space for accommodating the diaphragm and the sensor formed in the fan unit through the hole in the nose cup and the hole in the face piece when the fan unit and the nose cup are connected to the face piece.

In accordance with a preferred embodiment of the present invention, the hole in the nose cup and the hole in the face piece communicate with each other when a drum formed on the nose cup to surround the hole in the nose cup resiliently fits on a drum formed on the face piece to surround the hole in the face piece.

The fan unit is usually made of hard resin material of high strength considering that high stressed portions are generated locally due to the usage of screws for fixing various components accommodated in the fan unit. Corresponding to the fan unit, the portion of the face piece connected to the fan unit is also usually made of hard resin material of high strength. On the other hand, the nose cup is made of flexible silicone resin material. Therefore, it is desirable to form a drum on the nose cup for surrounding the hole in the nose cup and a drum on the face piece for surrounding the hole in the face piece, and resiliently fit the drum of the nose cup on the drum of the face piece so as to reliably communicate the hole in the portion of the face piece made of hard material and connected to the fan unit with the hole in the nose cup made of flexible material.

In accordance with a preferred embodiment of the present invention, the breathing apparatus further comprises a pressure sensor for detecting the internal pressure of the face piece, and wherein the fan unit is provided with a light source to be activated when negative pressure is detected in the face piece, and an observation window is formed in the face piece to oppose the light source when the fan unit is connected to the face piece.

The light of the light source is directed into the face piece through the observation window because the light source activated when negative pressure is detected in the face piece is provided on the fan unit connected to the face piece and the observation window is formed in the face piece to oppose the light source provided on the fan unit. Thus, the user of the breathing apparatus can notice the lighting of the light source without fail.

In accordance with a preferred embodiment of the present invention, the light source is shut off from the environment when the fan unit is connected to the face piece.

The light source is protected from damage due to collision with foreign matter because it is shut off from the environment when the breathing apparatus is used.

In accordance with a preferred embodiment of the present invention, the light source is enclosed by opaque members except for the observation window.

The aforementioned structure increases the amount of luminous flux passing through the observation window. Thus, the user of the breathing apparatus more certainly notices the lighting of the light source.

In accordance with a preferred embodiment of the present invention, the pressure sensor for detecting the internal pressure of the face piece is the breath monitoring apparatus.

When the breath monitoring apparatus is also the sensor for detecting the internal pressure of the face piece, the number of members constituting the breathing apparatus is reduced.

In accordance with a preferred embodiment of the present invention, the fan unit is detachably connected to the front of the face piece, the fan unit accommodates a power supply battery, and the face piece is provided with an exhale valve at the side face.

When the breath monitoring apparatus is constituted of an exhale valve and a sensor for detecting movement of the exhale valve, it is reasonable to dispose the sensor on the fan unit and not on the face piece which is washed in water, and dispose the exhale valve on the portion of the face piece connected to the fan unit. However, when the breath monitoring apparatus is constituted of a diaphragm and a sensor for detecting movement of the diaphragm disposed in the fan unit, and the space for accommodating the diaphragm is communicated with the internal space of the nose cup, there is no reasonable ground to dispose the exhale valve on the portion of the face piece connected to the fan unit. Therefore, in this case, it is most reasonable to dispose the exhale valve on a portion of the face piece other than that connected to the fan unit insofar as the fan unit accommodates the power supply battery.

When the exhale valve is disposed on the side face of the face piece, the fan unit can be closely connected to the front of the face piece because no space need be provided for exhale air between the front of the face piece and the fan unit. Thus, the fan unit is prevented from projecting excessively from the front of the face piece even if the fan unit increases in thickness because it accommodates the power supply battery.

The side face of the face piece opposes the side face of the nose cup. The side face of the face piece and the side face of the nose cup are given fairly wide areas. Therefore, the side face of the face piece and the side face of the nose cup are suitable sites for installing the exhale valve and the connecting portions between the nose cup and the exhale valve.

In accordance with a preferred embodiment of the present invention, the face piece is provided with an exhale valve at either side face.

When a plurality of exhale valves are disposed on the face piece, exhale resistance decreases and the convenience of the breathing apparatus increases.

### BRIEF DESCRIPTION OF THE DRAWINGS

FIG. 1 is a front view of a breathing apparatus in accordance with a preferred embodiment of the present invention.

FIG. 2 is a side view of a breathing apparatus in accordance with a preferred embodiment of the present invention.

FIG. 3 is an exploded perspective view of a breathing apparatus in accordance with a preferred embodiment of the present invention as seen from the front.

FIG. 4 is an exploded perspective view of a breathing apparatus in accordance with a preferred embodiment of the present invention as seen from the rear.

FIG. 5 is a side sectional view of a breath monitoring apparatus in accordance with a preferred embodiment of the present invention.

FIG. 6 is a sectional view of the face piece and the nose cup of a breathing apparatus in accordance with a preferred embodiment of the present invention as seen from the rear.

FIG. 7 is a perspective view of a breathing apparatus in accordance with a preferred embodiment of the present invention as seen from the rear.

### MODES FOR CARRYING OUT THE INVENTION

A breathing apparatus in accordance with a preferred embodiment of the present invention will be described.

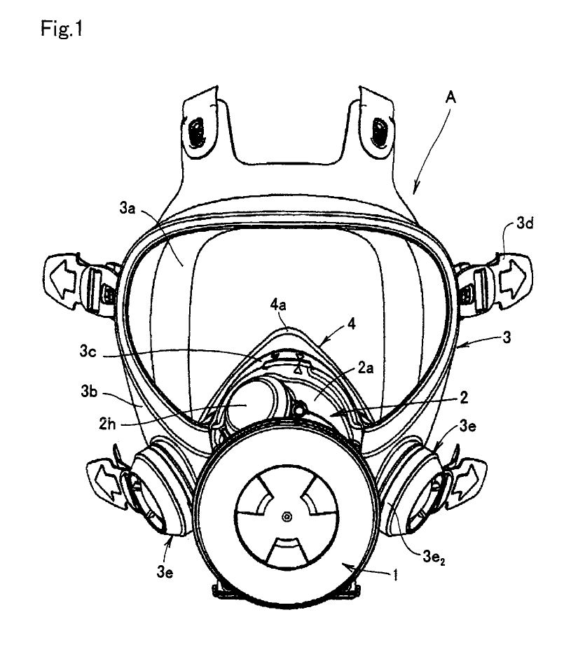

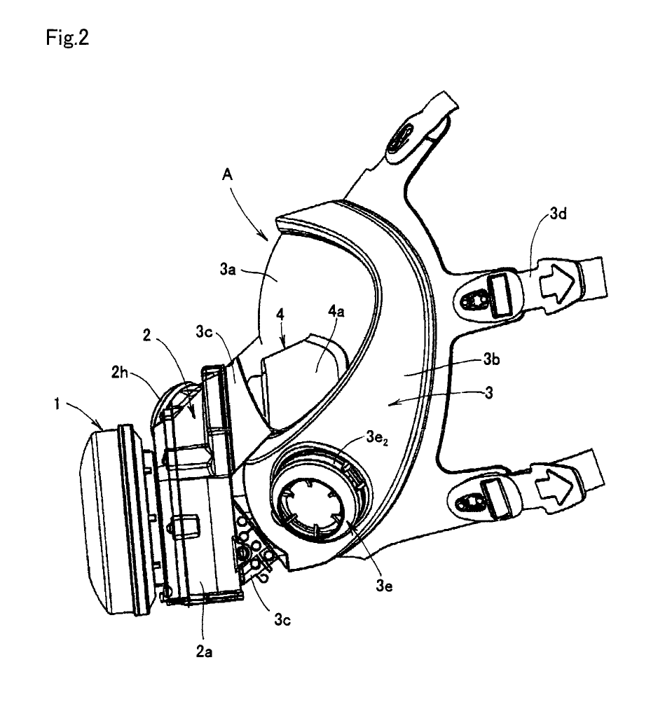

As shown in FIGS. 1 to 7, a breathing apparatus A comprises a filter 1, a fan unit 2, a face piece 3 for covering the whole face of a user, and a nose cup 4 for covering the nose and the mouth of the user.

The filter 1 is detachably connected to the fan unit 2, the fan unit 2 is detachably connected to the face piece 3 from the outside of the face piece 3, and the nose cup 4 is detachably connected to the face piece 3 from the inside of the face piece 3.

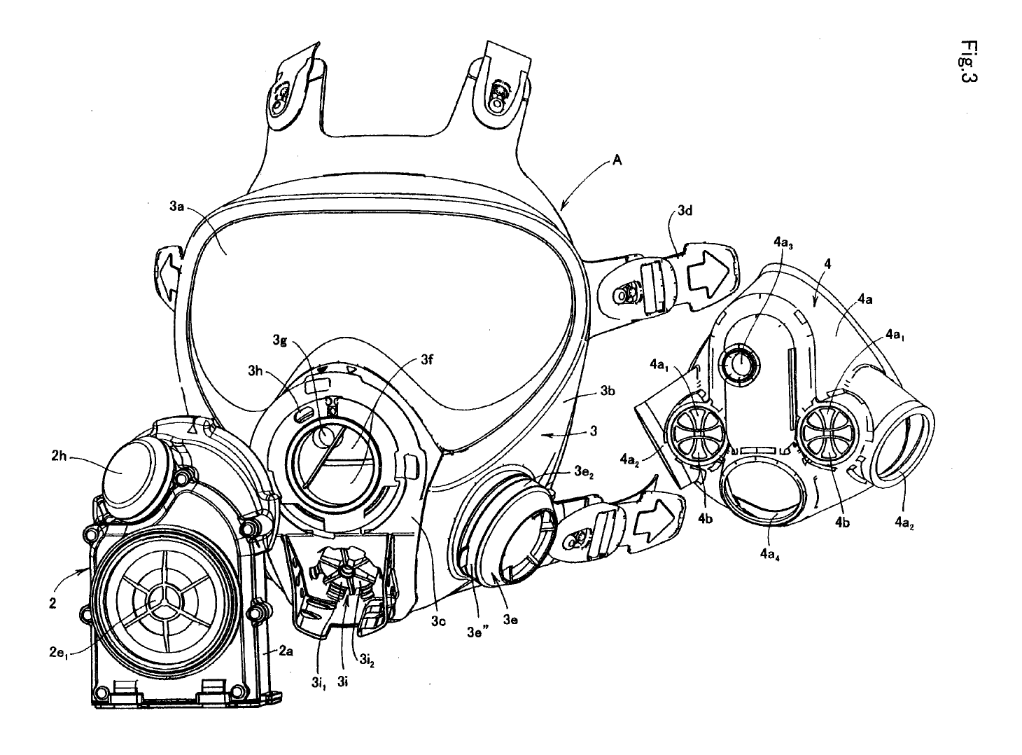

As shown in FIGS. 3 to 5, the fan unit 2 comprises a body 2a. The body 2a accommodates a power supply battery 2b, a motor 2c supplied with electric power from the power supply battery 2b, a centrifugal fan 2d driven by the motor 2c, and a controller 2c₁ for controlling the operation of the motor 2c.

An air passage 2e penetrates the body 2b. The air passage 2e extends from an inlet 2e₁ formed in the portion to be connected to the filter 1 through a space accommodating the fan 2d to an outlet 2e₂.

A through hole 2f is formed in the body 2a independently of the air passage 2e. The through hole 2f is closed by a diaphragm 2g at one end 2f₁ close to the filter 1. A sensor 2g₁ is disposed in the through hole 2f so as to oppose the diaphragm 2g and detect the displacement of the diaphragm 2g. The sensor 2g₁ is connected to the controller 2c₁. The sensor 2g₁ may be a magnetic sensor for detecting fluctuation of the magnetic flux density of a magnet attached to the diaphragm 2g or a photo sensor for shining a light beam onto the diaphragm and detecting fluctuation of the strength of the light beam reflected from the diaphragm. A cover member 2h provided with a small through air hole covers the diaphragm 2g from the outside of the body 2a. The other end 2f₂ of the through hole 2f adjoins the outlet 2e₂ of the air passage 2e. The diaphragm 2g, the sensor 2g₁ and the controller 2c₁ cooperate to form a breath monitoring apparatus for detecting breath timing of the user of the breathing apparatus.

A LED 2i is disposed adjacent to the other end 2f₂ of the through hole 2f. The LED 2i is connected to the controller 2c₁.

The body 2a of the fan unit 2 is made of opaque hard resin material of high strength considering that high stressed portions are generated locally due to the use of screws for fixing various components accommodated in the body 2a.

The face piece 3 comprises an eye piece 3a made of transparent resin material for covering the front portion of the face of the user, a face seal 3b made of silicone rubber for covering the top portion and either side portion of the face of the user, and a connecting portion 3c to be connected to the fan unit 2. The connecting portion 3c is disposed in front of the face piece 3. The eyepiece 3a, the face seal 3b and the connecting portion 3c are assembled as a unitary body. For good matching with the fan unit body 2a made of hard material, the connecting portion 3c is made of the same hard material as the fan unit body 2a.

A plurality of fastening straps 3d are connected to the face seal 3b so as to fix the face piece 3 to the head of the user.

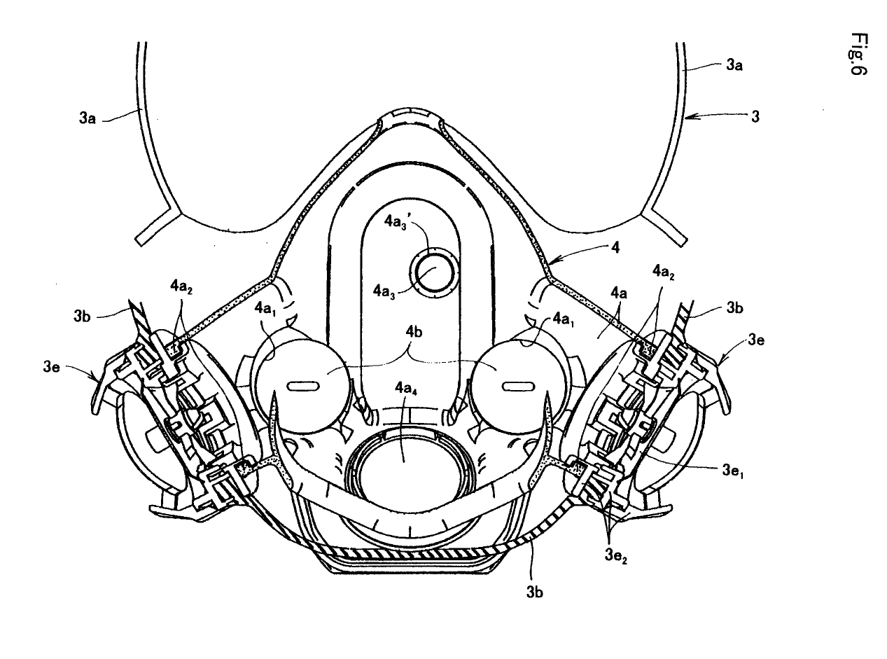

As shown in FIGS. 1 and 6, a pair of exhale valve assemblies 3e, each comprising an exhale valve 3e₁ and a drum 3e₂ for holding the exhale valve 3e₁, are connected to opposite side portions of the face seal 3b opposing the opposite side portions of the user's face.

The connecting portion 3c is provided with holes 3f and 3g independent of each other and adjacent to each other and a hole 3h close to the hole 3g. The hole 3g is surrounded by a drum 3g₁.

The connecting portion 3c is provided with a speaking diaphragm 3i comprising a hole 3i₁ formed in the connecting portion 3c, a membrane 3i₂ for closing the hole 3i₁ and a drum 3i₃ for supporting the membrane 3i₂.

The nose cup 4 comprises a body 4a made of silicone rubber. The body 4a is provided with a pair of inhale holes 4a₁, a pair of exhale valve connecting drums 4a₂, a hole 4a₃ and a speaking diaphragm connecting hole 4a₄. Each of the inhale holes 4a₁ is provided with an inhale valve 4b. The hole 4a₃ is surrounded by a drum 4a₃′.

The filter 1 is screwed on the fan unit 2. The fan unit 2 is tightly abutted against and connected to the connecting portion 3c of the face piece 3 from the outside of the face piece 3 by fixing claws. The nose cup 4 is connected to the face piece 3 from the inside of the face piece 3, by resiliently fitting the exhale valve connecting drums 4a₂ on the drums 3e₂ of the exhale valve assemblies 3e, resiliently fitting the drum 4a₃′ on the drum 3g₁ of the connecting portion 3c, and resiliently fitting the circumferential wall of the speaking diaphragm connecting hole 4a₄ on the drum 3i₃ of the speaking diaphragm 3i. When the nose cup 4 is connected to the face piece 3, a space is formed between them except at the portions connected to each other.

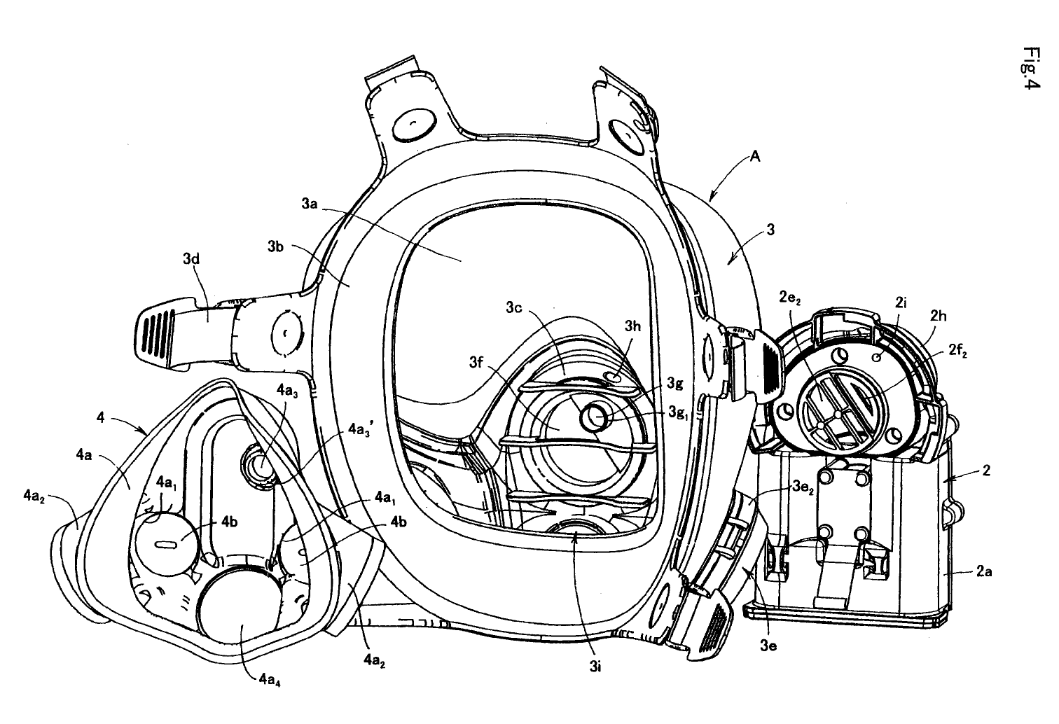

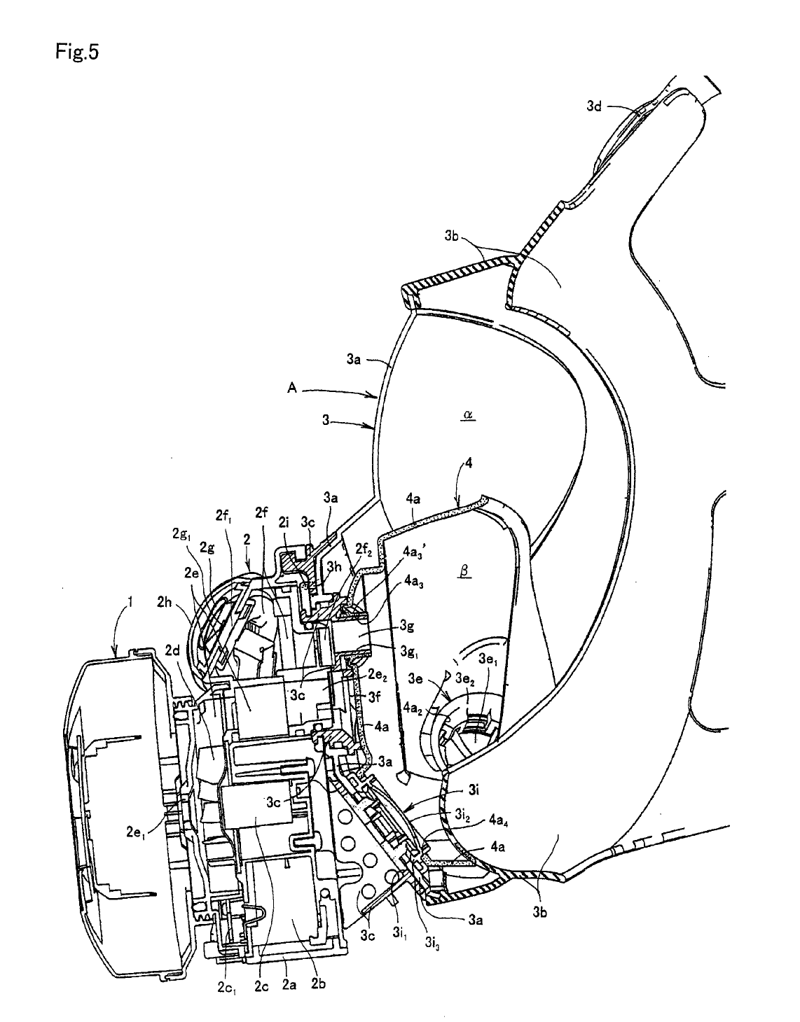

As can be seen from FIGS. 4 and 5, when the fan unit 2 and the nose cup 4 are connected to the face piece 3, the air passage outlet 2e₂ of the fan unit 2 communicates with the hole 3f of the connecting portion 3c of the face piece, and the hole 3f communicates with the internal space of the face piece 3 through the space between the nose cup 4 and the face piece 3. As a result, the air passage 2e of the fan unit 2 communicates with the internal space of the face piece 3.

As can be seen from FIGS. 4 and 5, when the fan unit 2 and the nose cup 4 are connected to the face piece 3, the other end 2f₂ of the through hole 2f of the fan unit 2 communicates with the hole 3g of the connecting portion 3c of the face piece 3, and the hole 3g communicates with the hole 4a₃ of the nose cup 4. As a result, the through hole 2f of the fan unit 2 communicates with the internal space of the nose cup 4.

As can be seen from FIGS. 3 to 5, the communicating portion between the air passage outlet 2e₂ and the hole 3f, and the communicating portion between the other end 2f₂ of the through hole 2f and the hole 3g are sealed off from the environment by an O-ring disposed on the fitting portion between a drum surrounding the air passage outlet 2e₂ and the other end 2f₂ of the through hole 2f and a drum surrounding the hole 3f and the hole 3g.

As can be seen from FIGS. 3 to 5, the communicating portion between the air passage outlet 2e₂ and the hole 3f is shut off from the communicating portion between the other end 2f₂ of the through hole 2f and the hole 3g because the boundary wall between the air passage outlet 2e₂ and the other end 2f₂ of the through hole 2f abuts the boundary wall between the hole 3f and the hole 3g. Therefore, the communicating portion between the air passage outlet 2e₂ and the hole 3f is reliably prevented from communication with the communicating portion between the other end 2f₂ of the through hole 2f and the hole 3g.

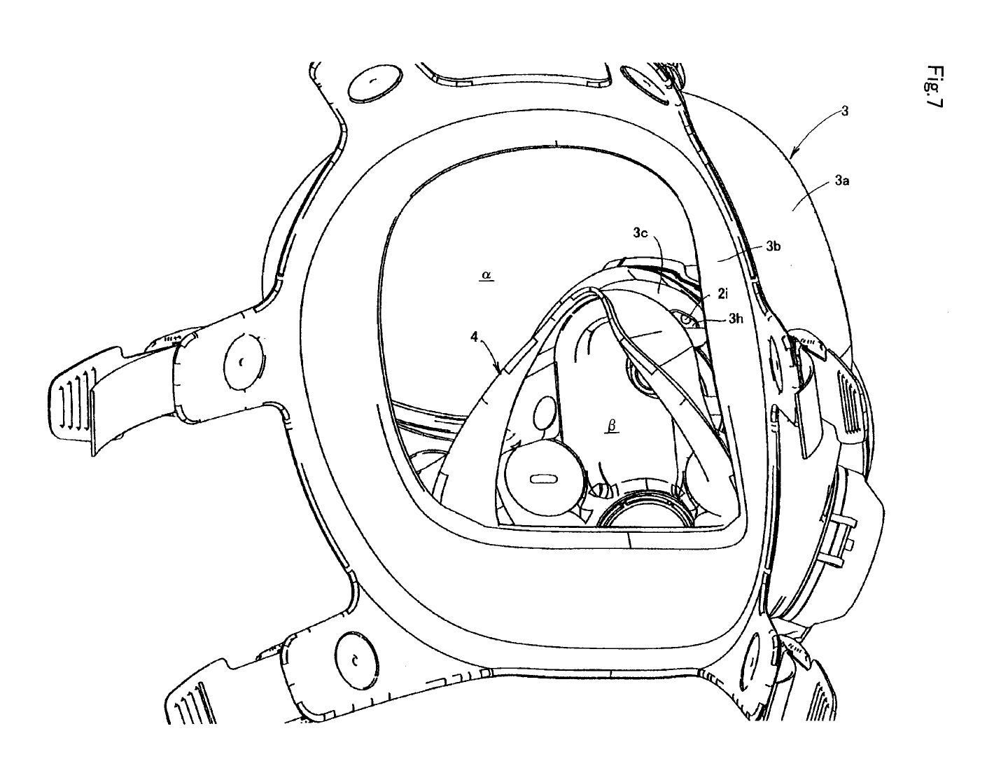

As can be seen from FIG. 5, when the fan unit 2 is connected to the face piece 3, the LED 2i opposes the hole 3h formed in the connecting portion 3c of the face piece 3, and the portion of the body 2a surrounding the LED 2i abuts the portion of the connecting portion 3c surrounding the hole 3h. As a result, the LED 2i is shut off from the environment. As can be seen from FIGS. 5 and 7, the user of the breathing apparatus can see the LED 2i from the inside of the face piece 3 through the observation window formed by the hole 3h and the portion of the eye piece 3a overlapping the connecting portion 3c.

Operation of the breathing apparatus A will be described.

When the user fits the breathing apparatus A on his or her face using the fastening straps 3d, the eye piece 3a of the face piece 3 covers the front portion of the face, the face seal 3b covers the top portion and the either side portion of the face so as to tightly abut the face, and the breathing apparatus A shuts the face of the user off from the environment. As shown in FIG. 5, the nose cup 4 covers the nose and the mouth of the user so as to abut the face of the user, thereby dividing the internal space of the face piece 3 into a first space α outside the nose cup 4 and a second space β inside the nose cup 4.

The first space α communicates with the environment through the hole 3f, the air passage 2e and the filter 1 and also with the second space β through the inhale valves 4b. The second space β communicates with the first space α through the inhale valves 4b and also with the environment through the exhale valves 3e₁.

When the user breathes, the internal pressure of the second space β fluctuates with the breathing, the internal pressure of the through hole 2f communicating with the second space β through the hole 4a₃ and the hole 3g, and the diaphragm 2g displaces. The displacement of the diaphragm 2g is detected by the sensor 2g₁, the detection signal is sent to the controller 2c₁, and the controller 2c₁ recognizes the fitting of the breathing apparatus A on the user. The motor 2c starts based on the control signal from the controller 2c₁, and the centrifugal fan 2d starts.

When the centrifugal fan 2d starts, environmental air passes through the filter 1 to become clean and flows into the first space α through the air passage 2e and the hole 3f, further into the second space β through the inhale valve 4b, and is inhaled by the user. The exhale air of the user is discharged to the environment through the exhale valve 3e₁.

The centrifugal fan 2 receives an operation signal from the controller 2c₁ to start when the sensor 2g₁ detects the displacement of the diaphragm 2g corresponding to the inhale of the user. The centrifugal fan 2 receives an operation signal from the controller 2c₁ to stop when the sensor 2g₁ detects the displacement of the diaphragm 2g corresponding to the exhale of the user. As a result, electric power consumption and exhale resistance become smaller than those in the case where the centrifugal fan 2d continuously operates.

In the breath monitoring apparatus comprising the diaphragm 2g and a sensor 2g₁ for detecting movement of the diaphragm 2g, no sensor need be disposed in the exhale air passage. Therefore, in the said breath monitoring apparatus, micro dust particles and water droplets dispersed in the exhale air are less likely to adhere to the sensor, the sensor is harder to be soiled, and the sensor is harder to deteriorate with age than in the conventional breath monitoring apparatus comprising an exhale valve and a sensor for detecting movement of the exhale vale.

The breath monitoring apparatus is desirably disposed in the fan unit 2 rather than the face piece 3 because the face piece 3 is detached from the fan unit 2 and washed in water. Inhalation/exhalation-induced air pressure fluctuation appears most clearly in the internal space of the nose cup 4. Therefore, the diaphragm 2g of the breath monitoring apparatus desirably receives air pressure in the internal space of the nose cup 4 so as to optimize the operation of the fan unit 2 synchronous to the breath timing.

Positioning of the diaphragm 2g and the sensor 2g₁ is optimized and a transmission path of inhalation/exhalation-induced air pressure fluctuation to the diaphragm 2g is optimized by disposing the breath monitoring apparatus in the fan unit 2, forming the fan unit 2 with the space 2f for accommodating the diaphragm 2g and the sensor 2g₁ independently of the air passage 2e, forming the face piece 3 with the hole 3g communicating with the space 2f when the fan unit 2 is connected to the face piece 3, forming the nose cup 4 with the hole 4a₃ communicating with the hole 3g of the face piece 3 when the nose cup 4 is connected to the face piece 3, and communicating the second space β, which is the internal space of the nose cup 4, to the space 2f of the fan unit 2 through the hole 4a₃ of the nose cup 4 and the hole 3g of the face piece 3 when the fan unit 2 and the nose cup 4 are connected to the face piece 3.

It is desirable to resiliently fit the drum 4a₃′ formed on the nose cup 4 and surrounding the hole 4a₃ on the drum 3g₁ formed on the face piece 3 and surrounding the hole 3g so as to reliably communicate the hole 3g formed in the portion of the face piece 3 made of hard material with the hole 4a₃ formed in the nose cup 4 made of flexible material.

When the internal pressure of the second space β becomes negative for a predetermined time duration, the controller 2c₁ recognizes said fact based on the detection of the displacement of the diaphragm 2g so as to light the LED 2i. As can be seen from FIG. 7, the user can see the lighting of the LED 2i from the inside of the face piece 3 through the observation window formed by the hole 3h disposed in the connecting portion 3c made of opaque resin material and the portion of the eye piece 3a made of transparent resin material abutting the connecting portion 3c.

The light of the LED 2i is directed into the face piece 3 through the observation window 3h as the LED 2i to be lightened when negative pressure is detected in the face piece is provided on the fan unit 2 connected to the face piece 3 and the observation window 3h is formed in the face piece 3 so as to oppose the LED 2i. Thus, the user of the breathing apparatus unfailingly notices the lighting of the LED 2i so as to perceive that the time has come to replace the filter 1 or the time has come to charge the power supply battery 2b.

The LED 2i is protected from damage due to collision with foreign matters as the LED 2i is shut off from the environment when the breathing apparatus A is used.

The LED 2i is enclosed by opaque resin material. The light of the LED 2i is directed into the face piece 3 through the observation window formed by the hole 3h provided in the connecting portion 3c made of opaque resin material. The aforementioned structure increases the amount of luminous flux passing through the hole 3h. Thus, the user of the breathing apparatus more certainly notices the lighting of the LED 2i.

The breath monitoring apparatus comprising the diaphragm 2g and the sensor 2g₁ is also the sensor for detecting negative pressure in the face piece 3. Thus, the number of members constituting the breathing apparatus becomes less than that in the case where the breath monitoring apparatus and the sensor for detecting the negative pressure are disposed independently of each other.

The breathing apparatus A becomes more convenient in the case where the power supply battery is accommodated in the body 2a of the fan unit 2 than in the case where the power supply battery is disposed independently of the fan unit.

When the breath monitoring apparatus is constituted of an exhale valve and a sensor for detecting movement of the exhale valve, it is reasonable to dispose the sensor on the fan unit and not on the face piece which is washed in water, and dispose the exhale valve on the portion of the face piece connected to the fan unit. However, when the breath monitoring apparatus is constituted of the diaphragm 2g disposed in the fan unit 2 and the sensor 2g₁ for detecting movement of the diaphragm 2g, and the space 2f for accommodating the diaphragm is communicated with the internal space β of the nose cup 4, there is no reasonable ground for disposing the exhale valve 3e₁ on the portion 3c of the face piece 3 connected to the fan unit 2. Therefore, in this case, it is most reasonable to dispose the exhale valve 3e₁ on a portion of the face piece 3 other than that connected to the fan unit 2 insofar as the fan unit 2 accommodates the power supply battery 2b.

When the exhale valves 3e₁ are disposed on the either side face of the face piece 3, the fan unit 2 can be located close to the connecting portion 3c in front of the face piece 3 and connected to the face piece 3 as no space need be provided between the connecting portion 3c in front of the face piece 3 and the fan unit 2 for easy flow of the exhale air. Thus, the fan unit 2 is prevented from projecting excessively from the front of the face piece 3 due to the fact that the fan unit 2 is increased in thickness by accommodation of the power supply battery 2b, and the breathing apparatus A is prevented from loss of convenience.

The side faces of the face piece 3 oppose the side faces of the nose cup 4. The side faces of the face piece 3 and the side faces of the nose cup 4 are given with fairly wide areas. Therefore, the side faces of the face piece 3 and the side faces of the nose cup 4 are suitable for installation of the exhale valve assemblies 3e and the exhale valve connecting drums 4a₂.

When the exhale valves 3e₁ are disposed on the either side of the face piece 3, exhale resistance decreases and the convenience of the breathing apparatus A increases.

### INDUSTRIAL APPLICABILITY

The present invention can be widely applied to breathing apparatuses.

### BRIEF DESCRIPTION OF THE REFERENCE NUMERALS

A Breathing Apparatus

1 Filter

2 Fan unit

2d Centrifugal fan

2e Air passage

2f Through hole

2g Diaphragm

2i LED

3 Face piece

3a Eye piece

3e₁ Exhale valve

3g Hole

3h Hole

4 Nose cup

4a₃ Hole

4b Inhale valve

1. A breathing apparatus comprising a filter, a fan unit, a face piece for covering the whole face of a user, a nose cup for covering the mouth and the nose of the user, and a breath monitoring apparatus, wherein the filter is detachably connected to the fan unit, the fan unit is detachably connected to the face piece from the outside of the face piece, the nose cup is detachably connected to the face piece from the inside of the face piece, and the fan unit operates synchronously with the breath timing of the user detected by the breath monitoring apparatus, and wherein the breath monitoring apparatus comprises a diaphragm and a sensor for detecting movement of the diaphragm, the breath monitoring apparatus is disposed in the fan unit, an air passage and a space independent of the air passage for accommodating the diaphragm and the sensor are formed in the fan unit, a hole is formed in the face piece to communicate with the space in the fan unit when the fan unit is connected to the face piece, a hole is formed in the nose cup to communicate with the hole in the face piece when the nose cup is connected to the face piece, and the internal space of the nose cup communicates with the space in the fan unit through the hole in the nose cup and the hole in the face piece when the fan unit and the nose cup are connected to the face piece.

2. A breathing apparatus of claim 1, wherein the hole in the nose cup and the hole in the face piece communicate with each other when a drum formed on the nose cup to surround the hole in the nose cup resiliently fits on a drum formed on the face piece to surround the hole in the face piece.

3. A breathing apparatus of claim 1, further comprising a pressure sensor for detecting the internal pressure of the face piece, and wherein the fan unit is provided with a light source activated when negative pressure is detected in the face piece, and an observation window is formed in the face piece to oppose the light source when the fan unit is connected to the face piece.

4. A breathing apparatus of claim 3, wherein the light source is shut off from the environment when the fan unit is connected to the face piece.

5. A breathing apparatus of claim 4, wherein the light source is enclosed by opaque members except for the observation window.

6. A breathing apparatus of claim 3, wherein the pressure sensor for detecting the internal pressure of the face piece is the breath monitoring apparatus.

7. A breathing apparatus of claim 1, wherein the fan unit is detachably connected to the front of the face piece, the fan unit accommodates a power supply battery, and the face piece is provided with an exhale valve at the side surface.

8. A breathing apparatus of claim 7, wherein the face piece is provided with exhale valves at either side surface.
